(19) United States
(12) Patent Application Publication
(10) Pub. No.: US 2008/0047312 A1
(43) Pub. Date: Feb. 28, 2008

(54) Systems and methods for production of absorbent material from manure

(75) Inventors: Jerry Hill, Cocoa, FL (US); Robert Nagro, Jupiter, FL (US); Joe Boylan, Tyler, TX (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(73) Assignee: TyraTech, LLC, Melbourne, FL (US)

(21) Appl. No.: 11/811,321

(22) Filed: Jun. 8, 2007

Related U.S. Application Data
(60) Provisional application No. 60/812,678, filed on Jun. 8, 2006.
(60) Provisional application No. 60/876,601, filed on Dec. 22, 2006.

(51) Int. Cl. C05F 3/00; C05F 3/06

(52) U.S. Cl. 71/21; 210/149; 422/291

(57) ABSTRACT

Systems and methods are provided for processing animal manure into a novel and useful product. The system utilizes the combined actions of a hydrocyclone, a dehydrator, and a reactor to clean, dry, and process manure into an absorbent material. The absorbent material, which contains low levels of salt, weed seeds, and pathogens, can be used for a variety of purposes, including but not limited to animal bedding and plant growth material.

### CROSS-REFERENCE TO RELATED APPLICATIONS

This application claims the benefit of priority under 35 U.S.C. §119(e) of U.S. Provisional Patent Application No. 60/812,678, filed Jun. 8, 2006, and U.S. Provisional Patent Application No. 60/876,601, filed Dec. 22, 2006, which are incorporated herein by reference.

### FIELD OF THE INVENTION

The present application relates to methods of processing animal manure. More particularly, this application relates to systems and methods for processing animal manure into an absorbent material.

### BACKGROUND OF THE INVENTION

Embodiments of the present invention address several problems faced by the agricultural industry. First, a solution is provided for the disposal of animal manure, thus reducing a significant expense for farmers and eliminating potential environmental hazards. Second, a natural substitute is provided for the increasingly scarce and expensive peat used in agricultural applications. Third, a fertilizer is provided that meets the regulatory requirements of organic farming. Fourth, an alternative source of bedding for farm animals is provided that is less expensive and safer than the traditional sources. Fifth, a platform is provided for insecticides, fungicides, pesticides, herbicides, and germicides. These solutions, as well as shortcomings of known approaches to these problems, are discussed herein.

### SUMMARY OF THE INVENTION

Embodiments of the present invention address the problems discussed herein by converting animal manure, a potential environmental hazard that farmers spend large amounts of money to dispose of, into a valuable product that can be used as a substitute for naturally occurring peat, a fertilizer for organic farming, and an animal bedding material.

In some embodiments of the present invention, a method is provided for producing an absorbent material. The method includes providing a manure material, including animal feces, wherein the material includes a first seed viability and a first pathogen viability. Seed viability at any stage of the process can be measured by exposing any seeds remaining in a given volume to germination-suitable conditions. The number of germinating seeds can then be divided by the total number of seeds present in an equal volume of the material Alternatively, seed viability can be measured by exposing any seeds remaining in a given volume of the final product to germination-suitable conditions. The number of germinating seeds can then be divided by either the total number of seeds present in an equal volume of the final product, or by the total number of seeds present in the starting material. Likewise, in any sample in which no seeds are detectable, or no seeds germinate, seed viability can be considered to have a value of 0%. The method further includes passing the material through a hydrocyclone system. The method further includes recovering a cleaned slurry from the hydrocyclone system, wherein the cleaned slurry includes a second seed viability that is lower than the first seed viability, and wherein the cleaned slurry further includes a second pathogen viability that is lower than the first pathogen viability. The method further includes dehydrating the cleaned slurry. The method further includes processing the dehydrated slurry in a reactor to form an absorbent material. The method further includes recovering the absorbent material from the reactor, wherein the absorbent material includes a nutrient, a third seed viability that is lower than the first seed viability, and a third pathogen viability that is lower than the first pathogen viability. In some embodiments, the third seed viability can be lower than the second seed viability, and the third pathogen viability can be lower than the second pathogen viability. In some embodiments, pathogen viability or pathogen count, involving a count of detectable pathogenic organisms in a given sample of the material. In some embodiments, pathogen count can focus on bacteria; in other embodiments it can focus on other pathogens; likewise, in some embodiments, it can include any detectable pathogens without regard to phylogenetic classification.

Another embodiment provides a manure processing system. The system includes a manure slurry intake. The system further includes a separation system, such as, for example, a hydrocyclone system in fluid communication with the intake, the hydrocyclone system including at least one hydrocyclone. The system further includes a dehydrator in fluid communication with the hydrocyclone system, the dehydrator including a dehydrator outlet. The system further includes a reactor downstream from the dehydrator, the reactor including a reactor inlet, and further including a reactor controller permitting regulation of temperature inside the reactor. Other separation systems can be employed as alternatives to hydrocyclone systems. In preferred embodiments, separation systems can separate based upon at least one of: separation of water from solids; separation of components by size; separation of components by density; separation of components by molecular weight; in addition, the separation system can further include application of a shear force to components of the slurry. In some embodiments, the system can include a mechanical or electromechanical device configured to selectively promote airflow through the reactor, such as a blower.

Another embodiment provides a system for manufacturing an absorbent material. The system includes a means for conveying a manure slurry from a collection pit. The system further includes a means for cleaning the manure slurry, wherein cleaning includes reducing a seed viability and a bacteria viability in the manure slurry, the cleaning means being in fluid communication with the conveying means. The system further includes a means for drying the cleaned slurry, the drying means being in fluid communication with the cleaning means. The system further includes a means for processing the dried slurry to an absorbent material, wherein processing includes maintaining the dried slurry at a temperature of at least about 140° F. for at least about 4 hours.

Another embodiment provides an absorbent material. The absorbent material includes at least one nutrient from animal manure. The absorbent material further includes a seed viability less than 20%, 15%, 10%, or 5% of the initial seed viability in the starting material. The absorbent material further includes a pathogen count less than 500,000, 400,000, 300,000, 200,000, 150,000, 100,000, 75,000, 50,000, or 25,000 per gram. In a preferred embodiment, the absorbent material has a moisture content of between 40 and 70%.

In some embodiments, the final material is substantially free of offensive or noxious odors. In some embodiments, substantially free of odors is indicated by an olfactometer as is known in the art. In other embodiments, freedom from odors is measured by behavior of animals in contact with the material. In other embodiments, freedom from odors is indicated by a blind smell recognition test, in which, in a random sampling of 10 test subjects, fewer than three are able to recognize the material as being derived from animal manure.

Embodiments of the invention provide methods of producing an absorbent material. The methods can include providing a manure material that contains animal feces wherein the manure material has a first seed viability and a first bacteria viability, passing the manure material through a hydrocyclone system, recovering a cleaned slurry from the hydrocyclone system wherein the cleaned slurry has a second seed viability that is lower than the first seed viability, and wherein the cleaned slurry further includes a second bacteria viability that is lower than the first bacteria viability. The methods can also include dehydrating the cleaned slurry, processing the dehydrated slurry in a reactor to form an absorbent material, and recovering the absorbent material from the reactor. These methods can generate an absorbent material that has a nutrient component, a third seed viability that is lower than the first seed viability, and a third bacteria viability that is lower than the first bacteria viability.

In some embodiments, the absorbent material can include less than about 3.0 EC mm/cm of salt. In other embodiments, the absorbent material can contain less than about 2.0 EC mm/cm of salt. In some embodiments the nutrient component has at least one undigested component of an animal feed. In some embodiments the nutrient component contains at least one element, including, for example, nitrogen, phosphorous, potassium, calcium, magnesium, sulfur, and the like. In preferred embodiments, the absorbent material can include one or more of the following: between about 1.1% and about 1.8% nitrogen, and the absorbent material can have between about 1700 ppm and about 2100 ppm phosphorous, between about 600 ppm and about 900 ppm potassium, between about 6000 ppm and about 6700 ppm calcium, between about 2200 ppm and about 3000 ppm magnesium, between about 60 ppm and about 90 ppm sulfur, can be substantially free of heavy metals, and can be substantially free of lead and mercury.

In some embodiments the absorbent material can have a moisture content of less than about 75%, 70%, 65%, 60% by weight or less. In some embodiments the absorbent material can have a water-holding capacity of at least about 4 times its own weight. In some embodiments the absorbent material can have a water-holding capacity of at least about 7 times its own weight. In some embodiments the absorbent material can be substantially free of putrid odors. Some embodiments can include agitating the manure material to facilitate suspension of solids in the manure material. In some embodiments the manure material has a first salt concentration, and the cleaned slurry has a second salt concentration, and the second salt concentration can be lower than the first salt concentration. In some embodiments the second salt concentration can be less than about 60% of the first salt concentration. In some embodiments the second salt concentration can be less than about 4 mmhos/cm. In some embodiments the manure material can include bovine manure, such as dairy cattle manure or beef cattle manure. In some embodiments the manure material can include swine manure. In some embodiments the manure material can include a solids content of between about 3% and about 15% by weight, such as, for example, between about 4% and about 12% by weight.

In some embodiments the passing step includes passing about 50, 100, 150, 200, 250, 300 gallons or more per minute or more of the manure material through the hydrocyclone system. In some embodiments the second seed viability is less than about 10%, 5%, or 1% of the first seed viability. In some embodiments the manure material has a first pathogen count, and the cleaned slurry has a second pathogen count, and the second pathogen count is lower than the first pathogen count. In some embodiments the second pathogen count is less than about 1% of the first pathogen count.

In some embodiments the cleaned slurry has a second pathogen count of less than about 75,000 per gram. In some embodiments the hydrocyclone system can have an inlet pressure between about 30 psi and about 55 psi. In some embodiments the dehydrated slurry can include a solids content of at least about 25% by weight. In some embodiments the dehydrating step can include a mechanical process for reducing moisture in the cleaned slurry. In some embodiments the dehydrating step can include passing the cleaned slurry through a screw press. In some embodiments the dehydrating step can include passing the cleaned slurry through a roller press. In some embodiments the processing step can include composting the dehydrated slurry. In some embodiments the processing step can include maintaining the dehydrated slurry at a temperature greater than about 140° F. for at least about 4 hours. In some embodiments the processing step can include maintaining the dehydrated slurry in the reactor at a temperature between about 140° F. and about 185° F. for between about 4 hours and about 24 hours. In some embodiments the processing step can include rotating the reactor. In some embodiments the rotating can include continuously rotating the reactor. In some embodiments the rotating can include discontinuously rotating the reactor. In some embodiments the rotating can include rotating the reactor between about 1 rotation and about 10 rotations per hour. In some embodiments the third bacteria viability can be less than the second bacteria viability. Some embodiments can include adding an insecticide to the absorbent material. In some embodiments the insecticide can include an essential oil. Some embodiments can include adding a fungicide to the absorbent material. Some embodiments can include adding a germicide to the absorbent material. Some embodiments can include adding a pesticide to the absorbent material. Some embodiments can include refining the absorbent material after the recovering step, to form a crop-specific mixture. Some embodiments can include, after the recovering step, admixing into the absorbent material for example, micronutrients, pH adjusters, and minerals, and the like.

Some embodiments of the invention provide a system of processing manure including a manure slurry intake, a hydrocyclone system including at least one hydrocyclone in fluid communication with the intake, a dehydrator with an outlet in fluid communication with the hydrocyclone system, and a reactor downstream from the dehydrator, with the reactor including a reactor inlet, and a reactor controller that can permit regulation of temperature inside the reactor. In some embodiments the manure slurry intake is in fluid communication with a manure source. In some embodiments the manure source can include a collection pit. In some embodiments the dehydrator can include a screw press. In some embodiments the dehydrator can include a roller press. In some embodiments the reactor can include a rotatable cylinder. Some embodiments can include a motor attached to the rotatable cylinder. In some embodiments the reactor can include a blower. In some embodiments the reactor controller can be in communication with a temperature detection unit that can be positioned to detect temperature inside the reactor.

In some embodiments the reactor controller can be configured to receive measurements from the temperature detection unit, and can also be configured to command at least one of a blower and a motor based on the measurements, wherein the blower is positioned to blow air into the reactor, and wherein the motor is coupled to a rotatable shaft connected to the reactor. In some embodiments the reactor controller can be configured to maintain a reactor temperature of at least about 140° F. for at least about 4 hours. In some embodiments the reactor controller can be configured to maintain a reactor temperature of at least about 160° F. for between about 4 hours and about 28 hours.

In some embodiments at least part of the manure processing system can be situated on a portable platform.

Embodiments of the invention provide methods for manufacturing an absorbent material, and can include a means for conveying a manure slurry from a collection pit, a means for cleaning the manure slurry, wherein cleaning includes reducing a seed viability and a bacteria viability in the manure slurry, where the cleaning means can be in fluid communication with the conveying means, and also included can be a means for drying the cleaned slurry, where the drying means can be in fluid communication with the cleaning means; and a means for processing the dried slurry to an absorbent material, wherein processing can include maintaining the dried slurry at a temperature of at least about 140° F. for at least about 4 hours. In some embodiments processing can include maintaining the dried slurry at a temperature of at least about 160° F. for between about 4 hours and about 28 hours. In some embodiments the absorbent material can include at least one undigested nutrient from animal manure. In some embodiments the absorbent material is substantially free of weed seed. In some embodiments the absorbent material can have a pathogen count of less than 75,000 per gram. In some embodiments the absorbent material can have a pathogen count of less than 50,000 per gram. In some embodiments the absorbent material can have less than 3.0 EC mm/cm salt. In some embodiments the absorbent material can have a water-holding capacity of at least about 4 times its own weight. In some embodiments wherein the absorbent material can have a water-holding capacity of at least about 7 times its own weight. In some embodiments at least part of the system can be positioned on a portable platform.

Embodiments of this invention can also provide an absorbent material having at least one nutrient from animal manure, and a seed viability less than 5%, and a pathogen count less than 75,000 per gram, with no noxious odor. In some embodiments the absorbent material can include less than about 3.0 EC mm/cm of salt. In some embodiments the absorbent material can include less than about 2.0 EC mm/cm of salt. In some embodiments the absorbent material can include, for example, nitrogen, phosphorous, potassium, calcium, magnesium, sulfur, and the like In some embodiments the absorbent material can be between about 1.1% and about 1.8% nitrogen, In some embodiments the absorbent material can be between about 1700 ppm and about 2100 ppm phosphorous. In some embodiments the absorbent material can be between about 600 ppm and about 900 ppm potassium. In some embodiments the absorbent material can contain between about 6000 ppm and about 6700 ppm calcium. In some embodiments the absorbent material can contain between about 2200 ppm and about 3000 ppm magnesium. In some embodiments the absorbent material can contain between about 60 ppm and about 90 ppm sulfur. In some embodiments the absorbent material can be substantially free of heavy metals. In some embodiments the absorbent material can be substantially free of lead and mercury. In some embodiments the absorbent material can have a moisture content of less than about 75% by weight. In some embodiments the absorbent material can have a moisture content of 60% by weight or less. In some embodiments the absorbent material can have a water-holding capacity of at least about 4 times its own weight. In some embodiments the absorbent material can have a water-holding capacity of at least about 7 times its own weight. In some embodiments the absorbent material can be substantially free of putrid odors. In some embodiments the absorbent material can include an insecticide. In some embodiments the absorbent material can include an insecticide that can include an essential oil. In some embodiments the absorbent material can include a fungicide. In some embodiments the absorbent material can include a germicide. In some embodiments the absorbent material can include a pesticide.

Some embodiments of the invention can provide animal bedding material that can include the absorbent material. In some embodiments the animal bedding material can include, for example, an insecticide, a germicide, a pesticide and the like. Some embodiments of the invention can provide a method of making a bedding material that can include admixing an absorbent material, with a material including, for example: an insecticide, a germicide, a pesticide and the like, and recovering a bedding material that can include an absorbent material. Some embodiments of the invention can provide a method of animal care that can include providing the bedding material, permitting the bedding material to absorb waste from the animal, and replacing the bedding material. Some embodiments of the invention can provide a plant growth material that can include the absorbent material. In some embodiments the plant growth material can also include, for example, soil, sand, peat, vermiculite, fertilizer, a nutrient, a mineral, and the like. Some embodiments of the invention can provide a method of making a plant growth material that can include an absorbent material, and the method can include providing the absorbent material, admixing therewith at least one material including, for example, soil, sand, peat, vermiculite, fertilizer, a nutrient, a mineral, a pesticide, a fungicide, a germicide; and the like, and recovering a plant growth material that can include an absorbent material.

These and other embodiments are described in greater detail below.

### BRIEF DESCRIPTION OF THE DRAWINGS

The appended drawings are schematic, not necessarily drawn to scale, and are meant to illustrate and not to limit embodiments of the invention. In the drawings, like numerals refer to like parts throughout.

FIG. 1 is a flow chart generally illustrating a process in accordance with embodiments of the present invention.

FIG. 2 is a schematic diagram generally illustrating a system in accordance with embodiments of the present invention.

FIG. 3 is another schematic diagram illustrating a system in accordance with embodiments of the present invention.

FIG. 4 shows a top view, a front view, and a side view of part of a system in accordance with embodiments of the present invention in an operating position.

FIG. 5 shows a top view, a front view, and a side view of part of a system in accordance with embodiments of the present invention in a transportation position.

FIG. 6 shows a top view and a side view of a system in accordance with embodiments of the present invention in an operating position.

FIG. 7 shows a top view, a front view, and a side view of an alternative system in accordance with embodiments of the present invention.

### DETAILED DESCRIPTION OF THE INVENTION

### Costs and Environmental Risks Associated with Disposal of Animal Manure

Agriculture is the second largest source of greenhouse gas (GHG) emissions in the world. Much of those GHG emissions are due to agricultural animals, which generate enormous quantities of manure every year. For example, the average daily cattle manure output is approximately 680,000 tons, while the average pig manure output is approximately 510,000 tons. In all, about 435 million tons of manure are produced per year, which are disposed at a cost of over $1 billion to farmers.

On dairy farms, economics have forced many farmers to increase their herd size without increasing their land base to account for the larger herd. Thus, many dairy farms have a high density of cows per area of land. This situation can lead to excessive nutrient loading on some farms, which raises health and environmental concerns. Over-application of manure has been implicated in nitrate contamination of ground water, fecal coliform contamination of shellfish beds, and nutrient loading of streams.

At present, a popular method for farms to handle animal waste is to convey it to holding lagoons. Once within these lagoons, which can be multi-acre in size, the waste decomposes. The solid and liquid wastes in the lagoons create an odor problem for the surrounding area, both as it decomposes in the lagoon and when the waste is later applied on croplands. After partially decomposing, some of the waste from the lagoons is applied to land as a fertilizer. The potential for environmental contamination during field application of the waste is substantial. For example, many fields in pork producing states have been over fertilized with waste from swine. Further, some of the applied fertilizer can become windborne during application, thus creating an additional source of environmental contamination for adjacent areas. Waste lagoon technology presents other problems, such as collapsed walls and ground leaching, both of which can contribute to waterway and well contamination. In one EPA report, 60% of the U.S. streams identified as “impaired” were polluted by animal wastewater.

On many farms, the solids from the waste lagoons are separated from the liquid components and disposed of off-site. Disposal of the solids can be costly for farmers, and may pose environmental risks as well. For example, methods that dispose of the solids by burning them contribute to GHG emissions.

Accordingly, a method for disposing of animal waste at minimal economic and environmental cost is desired.

Importance and Increasing Expense of Peat for Agricultural Applications

Peat is a naturally occurring accumulation of partially decayed vegetation matter. Peat forms when acidic conditions inhibit plant material from fully decaying. Peat is important in agricultural applications because when it is added into soil, it can increase the soil's capacity to retain moisture and add nutrients. However, because peat is a naturally occurring resource, its supply is limited. Further, peat must be transported from the location where it is found to the nursery or growing facility where it is to be used. The transportation costs can be substantial, as many of the major peat sources are overseas or in northern Canada. These factors contribute to the increasing cost of peat. Accordingly, it is desirable to find or produce a peat-like material that has the beneficial features of peat but is abundant and inexpensive to obtain.

Need for a Fertilizer that Meets Requirements for Organic Farming

The last three decades have seen a slow but steady move towards sustainable agricultural methods. Organic produce is one of the fastest growing markets in the United States today, with sales increasing by 20% annually. One requirement of certified organic growing is the use of natural fertilizers. As the sale of organic goods increases, the demand for natural fertilizers will likewise increase. Moreover, the USDA has ruled that organic farms may no longer use biosolid-based fertilizers if they wish to retain their organic certification. This means a greater demand for fertilizers that do comport with the requirements for organic certification. Accordingly, a natural fertilizer is needed that meets the demands of organic farming.

Need for Alternative Animal Bedding

On many farms, farmers pay for sand, which they then spread in the barns as bedding for the cows. Other farmers purchase wood chips for bedding instead. In either case, animals typically defecate into the material that is intended to be their bedding. One result of this is that the bulk of the bedding material is ultimately transferred to the manure lagoons, adding to the amount of lagoon solids that eventually must be disposed of. In addition, because the bedding is not always free of bacteria and pathogens, animals having prolonged contact with the bedding may become sick and/or infected. Accordingly, an alternate bedding material is needed that alleviates these problems.

As noted above, disposal of animal manure presents a number of financial and environmental challenges for the agricultural industry. Embodiments described herein provide systems and methods of converting animal manure into a useful product. The characteristics of this product can make it desirable in a wide variety of applications. For example, in some embodiments, the product contains nutrients from the undigested animal feed it is derived from, but has acceptably low levels of bacteria, weed seeds, pathogens, salt, and heavy metals. The product can also have a low moisture content and a high water-holding capacity.

Accordingly, this product can be used to address other challenges that face the agricultural industry. For example, the product can be used as an inexpensive substitute for naturally occurring peat in the same agricultural applications for which naturally occurring peat is currently in demand. The product can also be used as bedding material for animals. The product can also be used as part of a fertilizer regimen that complies with the requirements of organic farming. Other processes can be carried out to further refine the product to enhance its performance for certain applications. For example, insecticides, such as essential oil-based insecticides, can be added to the product. Fungicides, germicides, and herbicides, pesticides can also be added. In its use as a plant growth material, other ingredients may be added to the product to specifically target the needs of certain types of plants.

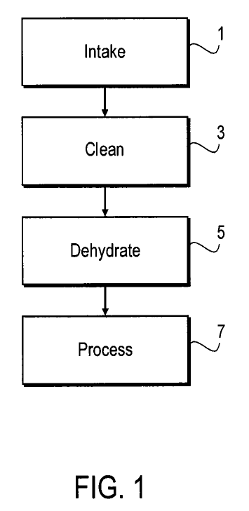

Embodiments of the present invention provide a method of producing an absorbent material, such as illustrated in FIG. 1. The method can include providing a manure material in step 1, cleaning the manure material in step 3 to form a cleaned slurry, dehydrating the cleaned slurry in step 5 to form a dehydrated slurry, and processing the dehydrated slurry in step 7 to form an absorbent material. In some embodiments, other processes can also be carried out to further refine the absorbent material after step 7. Processes as illustrated in FIG. 1 are discussed in greater detail herein below.

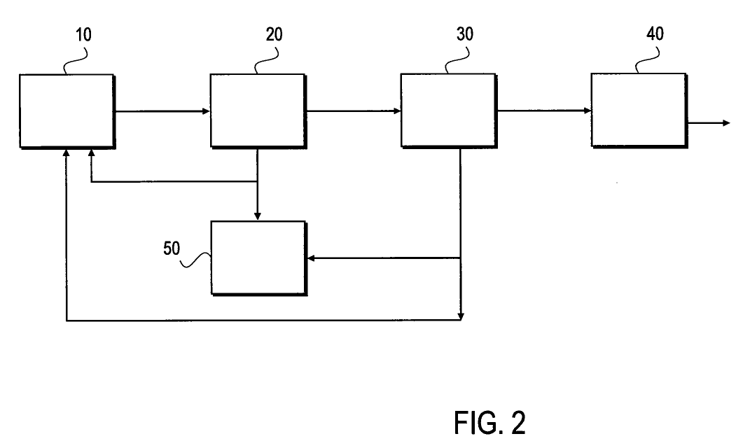

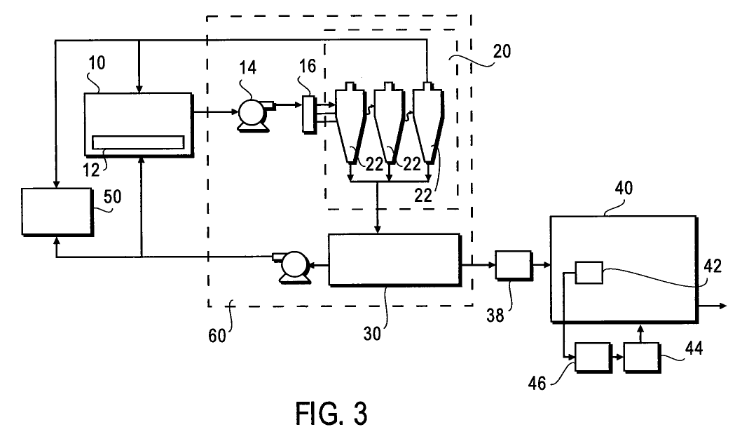

Embodiments of the present invention provide a system for processing manure, such as illustrated in FIGS. 2 and 3. As shown in FIGS. 2-3, the system can include a hydrocyclone system 20, a dehydrator 30, and a reactor 40. In some embodiments, the system can also include a collection pit 10 and a tank 50. Systems as illustrated in FIGS. 2-3 are discussed in greater detail herein below.

Intake

FIG. 1 is a flow chart generally illustrating a process in accordance with embodiments of the present application. In step 1 of FIG. 1, intake is performed. The intake step 1 includes providing a manure material including animal waste products and transferring manure material from the manure source into a cleaning unit for carrying out the clean in step 3. While preferred embodiments provide dairy cattle manure, other animal manure, such as beef cattle manure or other bovine manure or swine manure, can also be used in other embodiments. As used herein, the terms “conveying,” “transporting” and “transferring” are utilized to describe methods for moving mass from one location to another, including but not limited to utilizing a pump, gravity, auger, conveyor, and the like. In some embodiments, the manure material can be collected and stored in a collection pit, such as a holding tank, a lagoon, or another container. The collection pit can be equipped with a “float switch” that can begin system operation once sufficient manure material is collected. Once the level of the manure material falls below a certain level, operation of the system can be stopped until an adequate supply of manure material is replenished. Once initiated, the system can operate at a constant speed. In alternative embodiments, the speed of the system can be variable, and can be determined by sensors of such features as humidity, temperature, moisture of the material in a given segment of the system, and the like.

The system can include safety mechanisms including manual “stop” switches operable by the user. These switches can have the ability to shut off the system when activated.

The manure material can be agitated in the collection pit so that solid waste particles are maintained in suspension in the manure material. Animal urine can provide part of the fluids for the manure material, and additional water can also be added to facilitate a consistent solids content in the manure material. Preferably, the manure material has a solids content between about 3% and about 15% by weight, more preferably between about 4% and about 12% by weight, when the manure material is transferred during the intake step 1.

The system can be operate under the control of the stacking conveyor at the output end of the reactor. Operation of the system can then depend upon the removal of the processed absorbent material from the output.

Cleaning

In step 3 of FIG. 1, a clean is carried out, which can include forming a cleaned slurry. In some embodiments, the cleaning step 3 can reduce bacteria viability. In some embodiments, the cleaning step 3 reduces the pathogen count in the cleaned slurry to less than about 1% of the pathogen count in the manure material. For example, a pathogen count in the manure material can be 10 million per gram or more and cleaning can reduce the pathogen count to 75,000 per gram or less, preferably 50,000 per gram or less.

The cleaning step 3 can further reduce seed viability. In some embodiments, cleaning step 3 reduces the seed viability in the cleaned slurry to less than about 5%, preferably less than about 1%, of the seed viability in the manure material. In a preferred embodiment, cleaning step 3 forms a cleaned slurry that is substantially free of weed seeds.

The cleaning step 3 can further include reducing the salt concentration of the material. As used herein, salt includes sodium as well as other water soluble metals. In some embodiments, cleaning step 3 can reduce the salt concentration in the cleaned slurry to less than about 60%, preferably 50% or less, of the salt concentration in the manure material. For example, salt concentration in the manure material can be 6.0 EC mmhos/cm and cleaning step 3 can reduce the salt concentration to 3.0 EC mmhos/cm in the cleaned slurry. The cleaning step 3 can also include reducing the moisture content of the material, such as reducing the moisture content by between about 2% and about 10%. While the cleaning step 3 begins the process of cleaning the material, further cleaning can be carried out in later stages of the process as well. For example, in some embodiments, the bacteria viability and seed viability can be further reduced in the later processing step 7.

In a preferred embodiment, cleaning step 3 includes passing the material through a hydrocyclone system, which system can include one or more hydrocyclones. Other devices, such as centrifuges or screen boards, can also be used in the cleaning step 3. Advantageously, the cleaning process includes separation of components based upon size and/or molecular weight, and also can include subjection of the manure suspension to high shear forces, which can help to destroy certain seeds and pathogens, while reducing the viability of others. In most embodiments, a hydrocyclone is preferred because of its relatively low cost, its ability to separate particle size, the shear forces it imparts on materials passing through, and its capacity to handle high volumes of material in a continuous flow. Hydrocyclones are often used to separate relatively heavy components of a fluid from the lighter components. Hydrocyclones can accomplish this separation by pressurizing the fluid, then forcing the pressurized fluid into the interior of a section of a cone at an angle that is tangential to a circular cross-section of the cone. Outlets are provided at both the narrower end of the cone section and the wider end. This arrangement results in a cyclonic action that sends denser components through the outlet at the wider end and sends lighter components through the outlet at the narrower end. Further description of hydrocyclones is provided in U.S. Pat. No. 5,593,600, issued Jan. 14, 1997, the disclosure of which is hereby incorporated herein by reference.

Embodiments of the present application can configure the hydrocyclone system to accomplish other objectives beyond simply separating heavy from light components in the manure material. The hydrocyclone systems described herein can subject the manure material to a cyclonic action that achieves the functions of the cleaning step 3 discussed above, such as reducing the bacteria viability and the seed viability in the manure material to form a cleaned slurry. It is believed that these effects are achieved by virtue of the shear forces that the manure material is subjected to while passing through the hydrocyclone system. Specifically, it is believed that the shear forces can rupture or weaken the cell walls of bacteria and seeds in the manure material. The effect of the cyclonic action can be tailored by altering the diameter, length, and taper angle of the cone section of the hydrocyclone, as well as the inlet pressure and the fluid properties (e.g., solids content) of the manure material passing through the hydrocyclone. In some embodiments, the manure material can be pressurized by a pump so that the pressure at an inlet of the at least one hydrocyclone is between about 30 psi and 55 psi. Some embodiments use a hydrocyclone that is between about 36 inches and about 48 inches in length, has a diameter of between about and 6 inches and about 10 inches, and has a taper angle of between about 5° and about 12°. For example, a hydrocyclone used in some embodiments has a length of 42 inches, a diameter of 8 inches, and a taper angle of 10°. The skilled artisan will recognize that these parameters can be varied while still achieving the objectives of cleaning step 3. Preferably, the hydrocyclone assembly includes an electronic sensor that can activate an “emergency stop” switch in case of a mechanical problem with the hydrocyclone.

The cleaning step 3 can include passing greater than about 50 gallons per minute of the manure material through the hydrocyclone system. In some embodiments, the hydrocyclone system is configured so that each hydrocyclone has a capacity to handle a flow rate of between about 50 gallons per minute and about 500 gallons per minute, preferably between about 100 gallons per minute and about 300 gallons per minute. In such embodiments, the number of hydrocyclones in operation can be selected according to how quickly the material is desired to be processed. Further, in some embodiments, the cleaned slurry can be fed back in to the hydrocyclone system or into a second hydrocyclone system to carry out further cleaning of the cleaned slurry.

Dehydration

In step 5 of FIG. 1, dehydration is conducted, which can include a mechanical process for reducing the moisture content of the cleaned slurry. In some embodiments, dehydration can include passing the cleaned slurry through a screw press. For example, an auger enclosed in a wedge wire screen can press the cleaned slurry against a weighted exit door to filter and reduce moisture content in the cleaned slurry. A suitable screw press is available commercially from Bauer (Model: S-855 Separator) Gewerbegebib Herzfeld 59510, Lippacol, Germany. In some embodiments, dehydration can include, in addition or as an alternative to the screw press, passing the cleaned slurry through a roller press. After dewatering, the dewatered slurry can have a solids content of at least about 25% by weight. In some embodiments, the dehydration step 5 removes substantially all of the outside moisture from the cleaned slurry, and the later processing step 7 can remove moisture from the cells of the dehydrated slurry.

Processing

In step 7, the dehydrated slurry is composted in a reactor to form an absorbent material. In some embodiments, the processing step 7 includes maintaining the dehydrated slurry at a temperature greater than about 140° F., preferably greater than about 160° F., for at least about 4 hours. In a preferred embodiment, the processing step 7 includes maintaining the dehydrated slurry at a temperature between about 140° F. and about 185° F. for between about 4 hours and about 24 hours. In another embodiment, processing step 7 reduces the amount of moisture present in the material by between 5 and 20%.

In some embodiments, the processing step 7 can include composting. Composting can include subjecting the dehydrated slurry to high temperatures for a prolonged period of time in order to break down seeds and bacteria. Composting is primarily an oxidative process which removes many odorous compounds. Also, during composting, some organic solids can be converted to carbon dioxide, thus reducing volume, and easily volatilized nitrogen is lost. As used herein, composting does not require complete decomposition of organic matter.

Among other benefits of the processing step 7, the absorbent material can be stable and much less odorous than the initial manure. As noted above, the processing step 7 can also further clean the dehydrated slurry, such as by reducing the bacteria or pathogen viability and the seed viability, and by killing pathogens such as fecal coliform. The processing step 7 can also further reduce moisture content of the dehydrated slurry.

In a preferred embodiment, the processing step 7 is conducted in a cylindrical reactor, such as a rotatable, drum-type reactor. An in-vessel processing system can advantageously shorten the mesophilic (70-105° F.) and thermophilic (>105° F.) stages, more efficiently compost, and decrease pathogens, resulting in a safer and more valuable end product. In addition, in-vessel processing can maintain a rapid decomposition process year-round, regardless of external ambient conditions. The reactor can be rotated continuously or discontinuously during the processing step 7. The rotation can be driven by an attached motor, and the motor can be controlled by a reactor controller. The reactor can include continuous flights, or spines, spirally attached along its inner surface, to move the material from the input end toward the output end as the reactor turns. The reactor controller can command the motor to rotate the reactor based on measurements of the thermodynamic conditions inside the reactor as a way of maintaining consistency and/or adjusting the properties of the absorbent material. In an exemplary embodiment, the processing step includes rotating the reactor, on average, between about 1 rotation and about 10 rotations per hour. Preferably, the reactor includes an electronic sensor that can activate an “emergency stop” switch in case of a mechanical problem.

In some embodiments, the reactor controller can regulate temperature inside the reactor. The controller can communicate with a temperature detection unit positioned to detect temperature inside the reactor. The temperature detection unit can include any device suitable for accurately detecting temperature in the temperature range the reactor operates, such as a bi-metal mechanical thermometer, resistance temperature detector (RTD), thermistor, or thermocouple. The controller can communicate with a humidity detection unit positioned to detect humidity inside the reactor. The humidity detection unit can include any device suitable for accurately detecting humidity within the range the reactor operates, In some embodiments, the controller can also communicate with the motor driving rotation of the reactor and/or a blower positioned to blow warm, dry air into the reactor. The blower can be mounted at the output end of the system and is used to force air through the reactor, in a counterflow fashion. In some embodiments, the reactor contains multiple apertures through which the air can be discharged. The controller can receive measurements from the temperature detection unit and command the blower and/or the motor in response to measurements from the temperature detection unit outside a preselected temperature range. For example, in a preferred embodiment, the reactor controller is configured to maintain a reactor temperature of at least about 140° F. for at least about 4 hours, preferably at least about 160° F. for between about 4 hours and about 28 hours. In another preferred embodiment, the controller is configured to maintain a blower-controlled air flow rate of between 10 and 100 cubic feet per minute.

The absorbent material recovered from the reactor after the processing step 7 includes several advantageous properties. The absorbent material can include nutrients from undigested animal feed that formed part of the manure material. Such nutrients can include nitrogen, phosphorous, potassium, calcium, magnesium, and sulfur. Advantageously, these nutrients can be present in the absorbent material at a substantially higher concentration than in naturally occurring peat. For example, nitrogen content of the absorbent material can be between about 1.1% and about 1.8%, such as between about 1.3% and about 1.6%, compared to average nitrogen content in sphagnum peat moss of approximately 0.71%. The phosphorous content of the absorbent material can be between about 1700 parts per million (ppm) and about 2100 ppm. The potassium content of the absorbent material can be between about 600 ppm and about 900 ppm. The calcium content of the absorbent material can be between about 6000 ppm and about 6700 ppm. The magnesium content of the absorbent material can be between about 2200 ppm and about 3000 ppm. The sulfur content of the absorbent material can be between about 60 ppm and about 90 ppm. The table below compares the availability of certain other nutrients in sphagnum peat with that of an exemplary absorbent material of embodiments of the present application.

| | Sphagnum Peat | Absorbent Material |
|---|---|---|
| Nutrient | (parts per million) | (parts per million) |
| Phosphorus | 5 | 1900 |
| Potassium | 12 | 750 |
| Calcium | 168 | 6350 |
| Magnesium | 28 | 2628 |
| Sulfur | 2 | 75 |

The absorbent material can have a lower seed viability than the manure material, preferably a seed viability less than 5%, preferably less than 3%, still more preferably less than 1%. Preferably, the absorbent material is substantially free of weed seed. The absorbent material can have a lower bacteria count than the manure material. Preferably, the absorbent material includes a pathogen count of less than 75,000 per gram, more preferably less than 50,000 per gram.

The absorbent material can also have a low salt content. Preferably, the absorbent material includes less than 3.0 EC mmhos/cm salt, more preferably less than 2.0 EC mm/cm salt. The absorbent material can also be substantially free of heavy metals, such as lead and mercury. The absorbent material can also include a low moisture content, such as less than about 75% by weight. In some applications where a lower moisture content is desirable, the absorbent material includes a moisture content of 60% by weight or less. The absorbent material can also include a high water-holding capacity, such as at least about 4 times its own weight, preferably at least about 7 times its own weight. These characteristics make the absorbent material a good candidate for use in fertilizers, soil additives, and animal bedding.

Further Refining

Further, the beneficial characteristics of the absorbent material can be enhanced and tailored to specific applications by carrying out other processes to further refine the absorbent material after the processing step 7. In some embodiments, an insecticides can be admixed into the absorbent material. Preferably, the insecticide includes at least one of the following:

2-phenethyl propionate; 2-phenethyl propionate, eugenol; 2-phenethyl propionate piperonyl butoxide; 2-phenethyl propionate, pyrethrins; 2-phenethyl propionate, thyme oil, pyrethrins; 4-aminopyridine; 4-quatemary ammonium compounds; abamectin; acephate; acetamiprid; acetic acid; adhesive tape; anti-corrosive detergent; avermectin; azadirachtin; baygon; β-cyfluthrin; bifentrhin; boric acid; brodifacoum; bromadiolone; bromethalin; carbaryl; castor oil & Fuller's earth clay; cedar mint, lemon grass, cinnamon; chlorfenapyr; chlorophacinone; cholecalciferol; cyfluthrin; cypermethrin; δ-methrin; d-limonene; d-trns allethrin, phenotrhin; difethialone; diflubenzuron; diphacinone; disodium octaborate tetrahydrate; D.O.T./didecyl; dimethyl ammonium chloride; esfenvalerate; etoc; eugenol, sodium lauryl sulfate; eugenol, thyme oil; fipronil; food bait; garlic; glyphosate; hexaflumuron; hydramethylnon; hydropene; imidacloprid; indoxacarb; λ-cyhalothrin; lemon grass, garlic & peppermint; linalool/MGK 264/Nylar (pyriproxyfen)/permethrin; linaloo/piperonyl butoxide; live bacteria and enzymes; malathion; metaldehyde; methomyl; microbial spores; microbial spores, citrus oil; mint oil; naphthalene; naphthalene & sulfur; nithiazine; noviflumuron; nylar (pyriproxyfen); nylar, etoc; oil of black pepper, piperine capsaicin; orthoboric acid; paradichlorobenzine; pentachloronitro benzene; pentahydrate borax; permethrin; pheromones; piperonyl butoxide; polybutene; prometron; propetamphos; propoxur; putrescent whole egg solids; putrescent whole egg solids, capsaicin; putrescent egg, mint, garlic; pyrethrin; pyrethrin/PBO; pyrethrin/PBO/N-octyl; pyrethrin/PIP; pyrethrin/(S)-methoprene; pyrethrins/piperonyl butoxide/MGK 264; pyrethrins/piperonyl butoxide; pyrethrum; pyripoxyfen; resmethrin; rosemary oil, peppermint oil; (S)-hydroprene; (S)-methoprene; sodium salt of diphacinone; sodium tetraborate decahydrate; strychnine; sulfuramid; sulfuryl fluoride; sumethrin; sumithrin and MGK 264; τ-fluvalinate; thiamethoxam; Z-9-tricosene; Z, E-9, 12 tetradecadien-1-ol; zinc phosphide.

In some embodiments, the insecticide can be an essential oil-based insecticide. Examples of preferred essential oils, and components that can advantageously be combined with essential oils, include: 2-methyl 1,3-cyclohexadiene, alpha terpinene, alpha-pinene, alpha-terpineol, beta pinene, borneol 1, black seed oil, camphene, camphor dextro, citral, decanal, dipropylene glycol (dpg), dl-alpha-tocopherol lineaolate, d-limonene, dodecanal, ethyl linalool, fenchol alpha, gamma-terpinene, geraniol, geranyl acetate, hedione, hercolyn d, isoborneol, isopar m, isopropyl myristate, lecithin, lilac flower oil, lime oil 410, linalool coeur, linalyl acetate, methyl salicylate, mineral oil white, myrcene, nonanal, octanal, para-cymene, piperonal (aldehyde), piperonyl alcohol, polyglycerol-4-oleate, potassium sorbate, sodium benzoate, sodium lauryl sulfate, soy bean oil, terpinene 4 ol, terpinolene, tetrahydrolinalool, thyme oil white, thymol, tocopherol gamma tenox, trans-anethole, triethyl citrate, tween 80, vanillin, wintergreen oil, and xanthan gum. Additional oils and components of essential-oil additives are recited in copending US Patent Publication No. 20050008714, which is incorporated herein by reference in its entirety. Other processes can also be carried out to enhance the absorbent material, such as admixing into the absorbent material a fungicide, a germicide, and/or a pesticide.

This further processing can provide tremendous advantages when the absorbent material is utilized in animal bedding applications, as the addition of bacterial- or viral-controlling materials can help to limit the effect and incidence of certain diseases that often afflict domestic animals. For example, mastitis is a bacterial inflammation of the udder that can negatively impact milk production and even lead to animal death. Economic loss due to mastitis has been estimated to reach $1.8 Billion USD annually. Controlling mastitis is dependent upon the use of proper milking techniques as well as maintaining sanitary conditions for the animals, and providing a bedding material that can inhibit bacterial growth can help milk producers ensure that the living conditions of their animals remain as sanitary as possible.

Furthermore, in addition to chemical enhancement of the absorbent material, processing can involve physical enhancements to the material's surface properties. For example, altering the electrical charges displayed on the surfaces of the absorbent material can make the material's surface a less-suitable environment for bacteria. Altering the these charges can also provide a mechanism by which bacterial contaminations can be contained or prevented, as recent studies in the field of bacteriology implicate surface charge as a mechanism for communication between the organisms.

In plant growth applications, the absorbent material can be further refined by admixing other ingredients, such as perlite or vermiculite, into the absorbent material for aeration. Other ingredients, such as soil, sand, fertilizer, pesticide, a nutrient, and/or a mineral can also be admixed to the absorbent material. Further, the absorbent material can be tailored to promoting growth in a particular region of a particular type of crop, such as fruits, vegetables, or ornamentals. Such tailoring can include admixing to the absorbent material micronutrients, pH adjusters, and/or minerals that improve the ability of a targeted region's native soil to grow a particular crop or crop type.

For example, crops particularly suited for growth and yield modification through use of the enhanced absorbent material include those typically grown on a scale that can lend itself to specialized attention to individual plants. Specialty crops of this sort can include many high-value “minor” or “niche” food crops such as mushrooms or ginseng, as well as non-food or ornamental crops such as Christmas trees, nursery crops, and greenhouse plants. Often, these types of crops are limited to cultivation in specific areas due to local soil conditions. However, because the refined absorbent material is so suitable for enhancement with regard to many soil characteristics, cultivation of these high-value crops can be expanded into areas previously unsuited for them.

As a further example, grape growers have adapted their vines to grow in many different climates and soils. However, local variations in soil composition have necessitated the use of additives and amendments to maintain preferable levels of nutrients, moisture, and acidity. In the case of wine grapes, vintners must pay particular attention to soil characteristics in order to achieve desired berry size, color, skin integrity, sugar content, and acidity. Minimum levels of many soil components such as nitrogen and potassium must be maintained. At the same time, soils that are overly “fertile,” or too high in nutrients, often produce fruit of lower quality, and so a delicate balance of nutrients is necessary to produce the best wines. In such situations, compositions including the refined absorbent material can be specifically, precisely tailored to provide optimal growth and yield conditions for the vines. Volumes of key components can be maintained, as well as the ratios between those components, which is of great importance in winemaking as these ratios can be as important as the total nutrient volumes available to the plants. For example, preserving a nitrogen/potassium ratio of 1:2 will minimize the effects of the fungus Botrytis cinerea, a common affliction of wine grapes.

As described, the absorbent material lends itself to enhancement such that the material can be used to form compositions with precise amounts and ratios of vital nutrients. In the case of compositions designed to provide an optimal growth medium for wine grapes, these will typically contain nitrogen levels ranging from 5 to 20% of total composition weight, potassium levels of between 10 to 40% of total composition weight, and phosphorus levels of between 0 and 10% of the total composition weight. Additionally, the composition can be chemically enhanced with pH adjusters such that it helps to maintain a relatively stable acidity. For example a pH of 7.0 can be maintained to maximize nutrient availability. Ratios of other nutrients can be adjusted to mimic conditions in other regions; for example, the soils of the Bordeaux region of France are typically rich in calcium, which tends to raise the pH of the soil. In contrast, the soils of Sonoma County, California tend to have very little calcium, and thus are more acidic. The absorbent material can be enhanced to reflect acidities on either end of the spectrum, and thus can be used to form compositions suitable for the growth of wines from any region. The absorbent material can also be treated to alter its subunit size, in order to provide various drainage efficiencies and maximize or minimize the surface area of the material exposed to the plant. Indeed, compositions utilizing the absorbent material can be designed to provide the optimum medium for almost any plant.

In addition to their effectiveness in providing the optimum growth medium for a plant, compositions made from the absorbent material can also be used to maintain that optimum medium. Following the production cycle of the crop, the plants themselves can be tested for uptake of the various nutrients. This information will indicate whether the original ratios and amounts of nutrients present in the absorbent material composition are affected by selective plant uptake. It can be the case that the plant of interest takes in a ratio of nitrogen to potassium that differs from the ratio present in the original composition. In such cases, the composition can be adjusted for use in succeeding growth cycles to maintain optimum plant levels of the various nutrients.

FIG. 2 schematically illustrates a system in accordance with embodiments of the present invention. A collection pit 10 holds the manure material including the animal manure. The hydrocyclone system 20 is in fluid communication with the collection pit 10. After the material passes through the hydrocyclone system 20, the cleaned slurry is transferred to the dehydrator 30. The fluids separated from the cleaned slurry in the hydrocyclone system 20 can be transferred to a separate tank 50 for further processing. Alternately or in addition to transferring the fluids to the separate tank 50, the fluids can be transferred to the collection pit 10 for dilution of new solid waste in the collection pit 10. The tank 50 can be, without limitation, a lagoon, a digester or a treatment pond. From the tank 50, fluids can be used to flush other manure, such as manure from a barn, into the collection pit 10. Such an arrangement advantageously provides a closed loop for fluids used in the system. In other embodiments, fluids from the tank 50 can be transferred to plants for aiding growth. For example, a pump can be used to convey fluids from the tank 50 through a piping system to crop fields. In other embodiments, fluids from the tank 50 can be transferred to a cargo vehicle, such as a truck or a train, and from there conveyed to other points of use for the fluids. Moisture removed from the cleaned slurry in the dehydrator 30 can also be transferred to the tank 50 and/or the collection pit 10. The dehydrated slurry from the dehydrator 30 is transferred to the reactor 40. After the dehydrated slurry is processed in the reactor 40, the absorbent material can be recovered from the reactor 40.

FIG. 3 shows schematically a more detailed version of a system according to some embodiments of the invention, which system can be used to carry out methods according to embodiments of the invention. FIG. 3 shows a collection pit 10, including an agitator 10 that assists in mixing and maintaining in suspension the solids of the manure material. A feed pump 14 can be used to flow the material from the collection pit 10 to the hydrocyclone system 20 and elevate the pressure of the material to a preselected inlet pressure for the hydrocyclone system 20. The hydrocyclone system shown in FIG. 3 includes more than one hydrocyclone 22, so a manifold 16 can be included to divide the flow of the material among the hydrocyclones 22 that are in operation. As described with reference to FIG. 2, fluids separated from the cleaned slurry in the hydrocyclone system 20 are transferred to the tank 50 and or the collection pit 10.

The dehydrator 30, which is in fluid communication with the hydrocyclone system 20, receives the cleaned slurry therefrom. Moisture removed from the cleaned slurry in the dehydrator 30 can be pumped to return to the collection pit 10 or to the tank 50. Fluids from the tank 50 can be transferred back into the system, such as by using the fluids to flush new manure into the collection pit 10. Fluids from the tank 50 can also be transferred outside of the system, such as by applying the fluids in crop fields. The dehydrated slurry can be transferred by a conveyor 38, such as a conveyor belt, to the reactor 40. In other embodiments, the dehydrated slurry is gravity-fed into the reactor 40, such as by sliding or dropping. The reactor 40 includes a temperature detection unit 42 in communication with a controller 46, and a motor 44 controlled by the controller 46. Once the dehydrated slurry has been sufficiently processed in the reactor 40, the absorbent material can be recovered therefrom.

As illustrated schematically in FIG. 3, at least part of the system, such as the hydrocyclone system 20 and the dehydrator 30 can positioned on a transportable platform 60. In other embodiments, other components, such as the reactor 40, can also be positioned on the same platform or on a separate platform. The platform 60 can permit much of the system to be mobile, so that the same system can be used on several different farms, creating efficiency for farms that do not produce enough manure to require the system to be in constant operation.

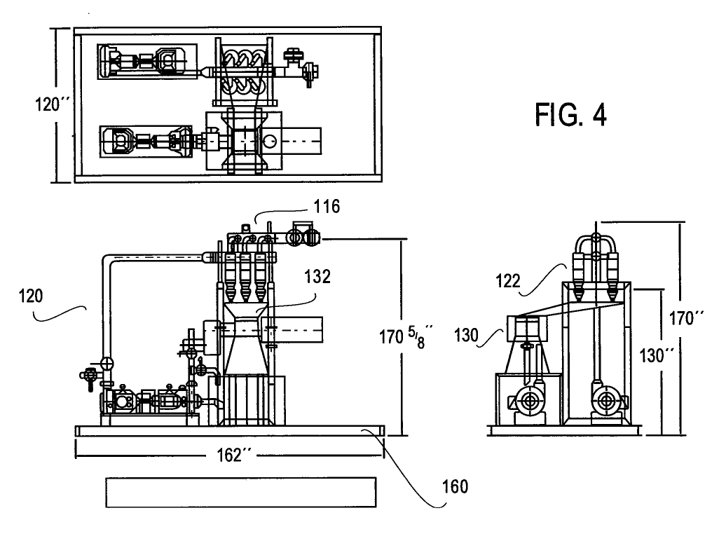

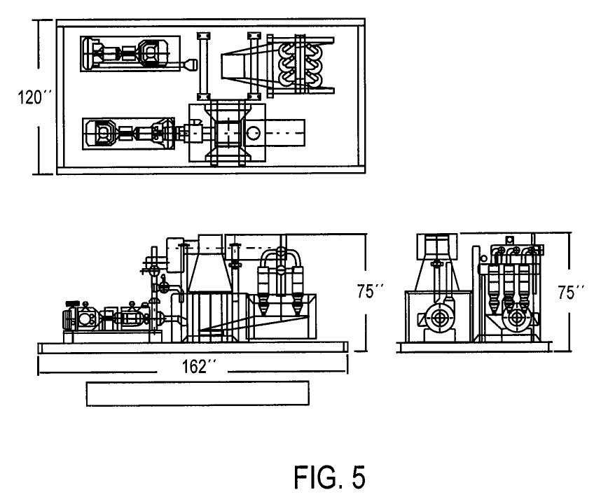

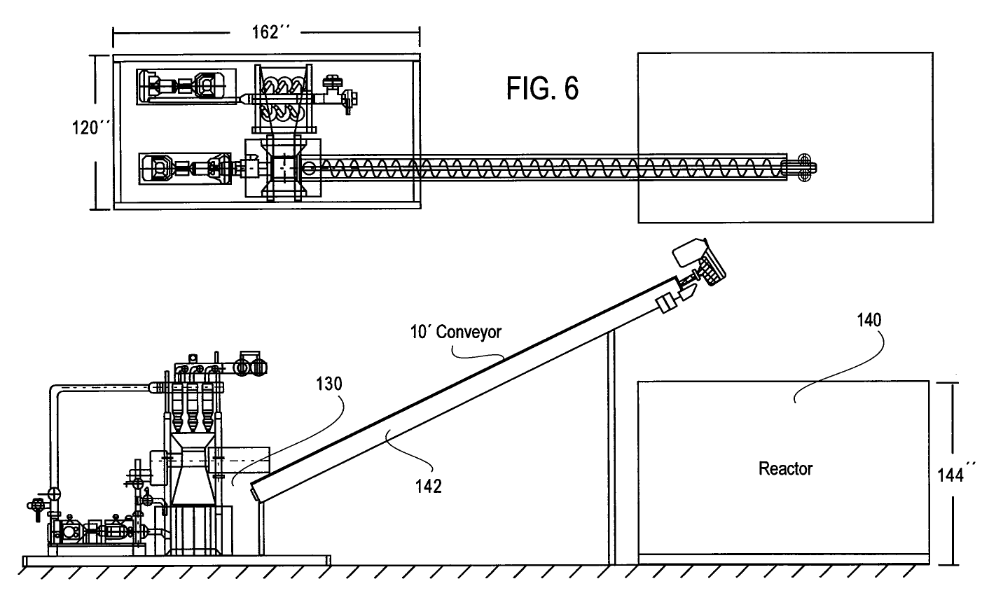

FIGS. 4-6 illustrate a system in accordance with embodiments of the present invention. FIG. 4 shows a top view, a front view, and a side view of part of the system in an operating position. FIG. 5 shows a top view, a front view, and a side view of part of the system in a transportation position. FIG. 6 shows a top view and a side view of the system in accordance with embodiments of the present invention in an operating position. In the system illustrated in FIGS. 4-6, a hydrocyclone system 120 is shown, including a plurality of hydrocyclones 122. A manifold 116 distributes the flow of manure material to inlets of the hydrocyclones 122. Although six hydrocyclones 122 are included in the system of FIGS. 4-6, the manifold 116 permits selection of which hydrocyclones 122 are fed manure material. Thus, the number of hydrocyclones 122 in operation can be varied depending on the amount of manure material desired to be processed. Cleaned slurry is conveyed, by dropping and sliding through a dehydrator intake 132, from the bottom of the hydrocylones 122 of the hydrocyclone system 120 into a dehydrator 130. FIGS. 4-6 show that the hydrocyclone system 120, the dehydrator 130, and other components such as pumps to facilitate movement of the fluids, can be positioned on a platform 160. Advantageously, the platform 160 can be a portable platform so that at least part of the system can be easily moved from one point of use to another, such as to service farms with low manure output. FIG. 5 illustrates that the components can be rearranged on the platform 160 to be more easily transportable. FIG. 6 illustrates the system with a reactor 140. Dehydrated slurry expelled from the dehydrator 130 can be conveyed into the reactor 140 by a conveyor 142.

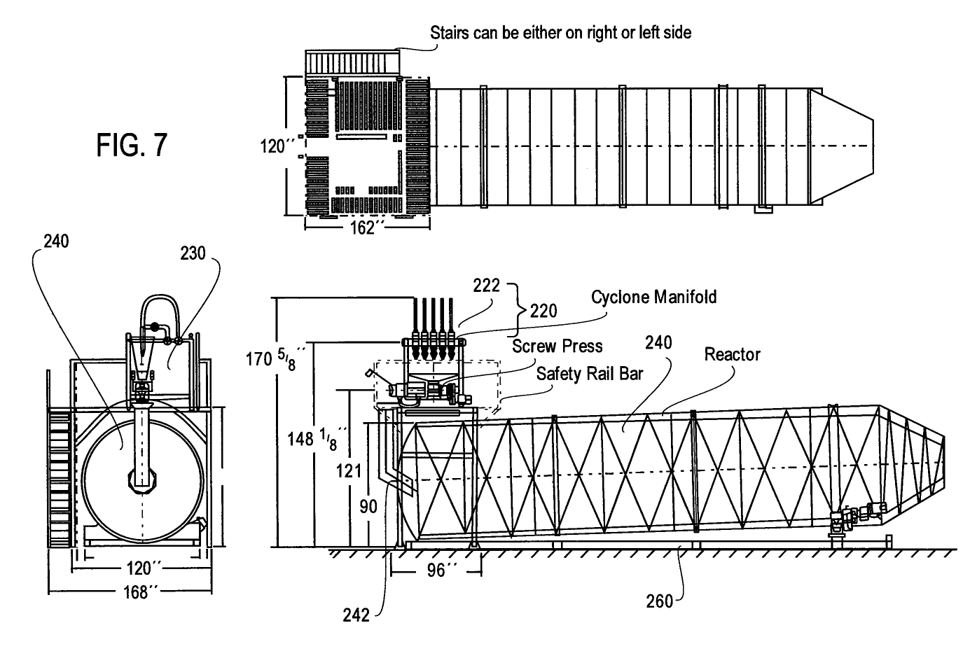

FIG. 7 shows a top view, a front view, and a side view of a system in accordance with embodiments of the present invention. In FIG. 7, a hydrocyclone system 220 is shown, which includes a plurality of hydrocyclones 222. A manifold 216 distributes the flow of materials passing through the hydrocyclone system 220 among the hydrocyclones 222 selected to be in operation. As noted above, the number of hydrocyclones 222 in operation can be varied depending on how much material is desired to be processed. As shown in FIG. 7, the outlets at the narrower ends (in the illustrated embodiment, the lower portions) of the hydrocyclones 222 of the hydrocyclone system 220 are positioned to gravitationally feed cleaned slurry into a screw press 230. Outlets at the wider ends (in the illustrated embodiment, the upper portion) of the hydrocyclones 222 feed into a piping system 224 that can convey the fluids to a collection pit, a tank, or to another point of use for the fluids, as described hereinabove with reference to FIGS. 2 and 3. The screw press 230 is positioned above a reactor 240, which advantageously allows the dehydrated slurry expelled from the screw press 230 to be gravitationally fed into the reactor 240 through a reactor inlet 242. As shown in FIG. 7, the hydrocyclone system 220 and the screw press 230 are positioned on a raised platform 260, which advantageously reduces the footprint of the system and permits the material passing through the system to be gravitationally from one portion of the system to the next. The reactor 240 is a cylindrical, drum-type reactor that is configured to be rotated by the motor 244 as the dehydrated slurry is processed into an absorbent material.

It will be appreciated by those skilled in the art that various other omissions, additions, and modifications may be made to the methods and systems described above without departing from the scope of the invention. All such changes are intended to fall within the scope of the invention, as defined by the appended claims.

We claim:

1. A method of producing an absorbent material, the method comprising:
providing a manure material comprising animal feces, wherein the manure material comprises a first seed viability and a first pathogen count;
passing the manure material through a separation system;
recovering a cleaned slurry from the separation system, wherein the cleaned slurry comprises a second seed viability that is lower than the first seed viability, and wherein the cleaned slurry further comprises a second pathogen count that is lower than the first pathogen count;
dehydrating the cleaned slurry;
processing the dehydrated slurry in a reactor to form an absorbent material; and
recovering the absorbent material from the reactor, wherein the absorbent material comprises a nutrient, a third seed viability that is lower than the first seed viability, and a third pathogen count that is lower than the first pathogen count.

2. The method of claim 1, wherein the absorbent material comprises less than about 3.0 EC mmhos/cm of salt.

3. The method of claim 1, wherein the absorbent material comprises less than about 2.0 EC mmhos/cm of salt.

4. The method of claim 1, wherein the nutrient comprises at least one undigested component of an animal feed.

5. The method of claim 1, wherein the nutrient comprises at least one of the group consisting of nitrogen, phosphorous, potassium, calcium, magnesium, and sulfur.

6. The method of claim 5, wherein the absorbent material comprises between about 1.1% and about 1.8% nitrogen.

7. The method of claim 5, wherein the absorbent material comprises between about 1700 ppm and about 2100 ppm phosphorous.

8. The method of claim 5, wherein the absorbent material comprises between about 600 ppm and about 900 ppm potassium.

9. The method of claim 5, wherein the absorbent material comprises between about 6000 ppm and about 6700 ppm calcium.

10. The method of claim 5, wherein the absorbent material comprises between about 2200 ppm and about 3000 ppm magnesium.

11. The method of claim 5, wherein the absorbent material comprises between about 60 ppm and about 90 ppm sulfur.

12. The method of claim 1, wherein the absorbent material is substantially free of heavy metals.

13. The method of claim 12, wherein the absorbent material is substantially free of lead and mercury.

14. The method of claim 1, wherein the absorbent material has a moisture content of less than about 75% by weight.

15. The method of claim 1, wherein the absorbent material has a moisture content of 60% by weight or less.

16. The method of claim 1, wherein the absorbent material has a water-holding capacity of at least about 4 times its own weight.

17. The method of claim 1, wherein the absorbent material has a water-holding capacity of at least about 7 times its own weight.

18. The method of claim 1, wherein the absorbent material is substantially free of putrid odors.

19. The method of claim 1, further comprising agitating the manure material to facilitate suspension of solids in the manure material.

20. The method of claim 1, wherein the manure material further comprises a first salt concentration, and wherein the cleaned slurry comprises a second salt concentration, and wherein the second salt concentration is lower than the first salt concentration.

21. The method of claim 20, wherein the second salt concentration is less than about 60% of the first salt concentration.

22. The method of claim 20, wherein the second salt concentration is less than about 4 EC mmhos/cm.

23. The method of claim 1, wherein the manure material comprises bovine manure.

24. The method of claim 23, wherein the manure material comprises dairy cattle manure.

25. The method of claim 23, wherein the manure material comprises beef cattle manure.

26. The method of claim 1, wherein the manure material comprises swine manure.

27. The method of claim 1, wherein the manure material comprises a solids content of between about 3% and about 15% by weight.

28. The method of claim 1, wherein the manure material comprises a solids content of between about 4% and about 12% by weight.

29. The method of claim 1, wherein the separation system comprises at least one of: separation of water from solids; separation of components by size; separation of components by density; separation of components by molecular weight; and application of a shear force to components.

30. The method of claim 29, wherein the separation system comprises a hydrocyclone system.

31. The method of claim 30, wherein the hydrocyclone system comprises multiple hydrocyclones in a parallel orientation with regard to flow.

32. The method of claim 30, wherein the hydrocyclone system comprises multiple hydrocyclones in a serial orientation with regard to flow.

33. The method of claim 30, wherein the hydrocyclone system comprises a single hydrocyclone.

34. The method of claim 1, wherein the passing step comprises passing about 50 gallons per minute or more of the manure material through a hydrocyclone system.

35. The method of claim 34, wherein the passing step comprises passing between about 100 gallons per minute and about 300 gallons per minute of the manure material through the hydrocyclone system.

36. The method of claim 1, wherein the second seed viability is less than about 5% of the first seed viability.

37. The method of claim 1, wherein the second seed viability is less than about 1% of the first seed viability.

38. The method of claim 1, wherein the second pathogen count comprises less than about 1% of the first pathogen count.

39. The method of claim 38, wherein the cleaned slurry comprises a second pathogen count of less than about 75,000 per gram.

40. The method of claim 1, wherein the hydrocyclone system comprises an inlet pressure between about 30 psi and about 55 psi.

41. The method of claim 1, wherein the dehydrated slurry comprises a solids content of at least about 25% by weight.

42. The method of claim 1, wherein the dehydrating step comprises a mechanical process for reducing moisture in the cleaned slurry.

43. The method of claim 42, wherein the dehydrating step comprises passing the cleaned slurry through a screw press.

44. The method of claim 42, wherein the dehydrating step comprises passing the cleaned slurry through a roller press.

45. The method of claim 1, wherein the processing step comprises composting the dehydrated slurry.

46. The method of claim 1, wherein the processing step comprises maintaining the dehydrated slurry at a temperature greater than about 140° F. for at least about 4 hours.

47. The method of claim 46, wherein the processing step comprises maintaining the dehydrated slurry in the reactor at a temperature between about 140° F. and about 185° F. for between about 4 hours and about 24 hours.

48. The method of claim 1, wherein the processing step comprises rotating the reactor.

49. The method of claim 48, wherein rotating comprises continuously rotating the reactor.

50. The method of claim 48, wherein rotating comprises discontinuously rotating the reactor.

51. The method of claim 48, wherein rotating comprises rotating the reactor between about 1 rotation and about 10 rotations per hour.

52. The method of claim 1, further comprising adding to the absorbent material at least one additive selected from the group consisting of: an insecticide, a fungicide, an herbicide, a germicide, and a pesticide.

53. The method of claim 52, wherein the additive comprises an essential oil.

54. The method of claim 1, further comprising refining the absorbent material to form a crop-specific mixture.

55. The method of claim 1, further comprising admixing into the absorbent material at least one of the group consisting of micronutrients, pH adjusters, and minerals.

56. A manure processing system comprising:
a manure slurry intake;
a separation system in fluid communication with the intake, the separation system separating on at least one basis selected from the group consisting of: separation of water from solids; separation of components by size; separation of components by density; separation of components by molecular weight; and wherein the separation system further comprises application of a shear force to components of the slurry;
a dehydrator in fluid communication with the separation system, the dehydrator comprising a dehydrator outlet; and
a reactor downstream from the dehydrator, the reactor comprising a reactor inlet, and further comprising a reactor controller permitting regulation of temperature inside the reactor.

57. A system for manufacturing an absorbent material, the system comprising:
a means for conveying a manure slurry from a collection pit;
a means for cleaning the manure slurry, wherein cleaning comprises reducing a seed viability and a pathogen count in the manure slurry, the cleaning means being in fluid communication with the conveying means;
a means for drying the cleaned slurry, the drying means being in fluid communication with the cleaning means; and
a means for processing the dried slurry to an absorbent material, wherein processing comprises maintaining the dried slurry at a temperature of at least about 140° F. for at least about 4 hours.

58. The system of claim 57, wherein at least part of the system is positioned on a portable platform.
